(19) United States
(12) Patent Application Publication
(10) Pub. No.: US 2011/0271853 A1
(43) Pub. Date: Nov. 10, 2011

(54) ROLLER PAIR AND APPARATUS FOR ALIGNING A ROLLER PAIR

(76) Inventors: Alois Wesseler, Vreden (DE); Josef Winkelmann, Reken (DE); Thomas Terhechte, Speyer (DE)

(21) Appl. No.: 12/998,750

(22) PCT Filed: Nov. 26, 2009
(86) PCT No.: PCT/DE2009/001669

§ 371 Date: Jul. 27, 2011

(30) Foreign Application Priority Data
Nov. 28, 2008 (DE) 20-2008-015,780.3

(51) Int. Cl. B31F 1/07

(52) U.S. Cl. 101/23

(57) ABSTRACT

A roller pair for embossing web-shaped materials, consisting of a male part and a female part, which during operation are arranged in specified axial and radial positions to produce a nip, characterized in that at least one of the rollers has at least two markings on the shell surface thereof, of which two markings in each case in an extension form an angle α, with 0<α<90°, and wherein the markings are arranged depending on the stamping pattern.

The invention relates to an apparatus for aligning rotatively controlled elements, such as, for example, rollers or shafts, where an exactly synchronous running is aimed for, as well as to a corresponding roller pair. Such an apparatus is necessary for example for embossing applications by utilizing a roller pair, wherein a first roller carries a positive engraving (male part) and a second roller carries a negative engraving (female part). To prevent damaging of the rollers or to achieve a high-grade and reproducible embossing result, respectively, it must be ensured that the rollers are adjusted radially and axially in an exactly predetermined position with respect to another. This includes is also pre-adjustment of the distance of the rollers with respect to another, the so-called embossing nip, to impart the desired embossing height to the material which is to be embossed, thereby, however, not overly emboss the material or even destroy it.

Apparatus for embossing applications, so-called embossing mills or cassettes, are known from DE 297 16 031 U1. Actuation of the roller pair is achieved by use of a pair of gears which is adjusted exactly to the circumference of the embossing rollers. For maintaining the small tolerances previously described when pre-adjusting the two embossing rollers, it is mandatory that the pair of gears is exactly harmonized with the used roller pair. Often, a gear is constructed in a split configuration which allows to alter the gear clearance of the drive system.

For embossing cassettes known from the prior art, it is necessary, for each changing of rollers, to align the gears with respect to the roller engraving and to adjust the gear clearance manually. For each exchange of the roller pair, wherein the diameter of the mounted rollers deviates from the roller pair previously used, a correspondingly adapted gear set must therefore be chosen, since each gear pair merely covers a range of roller diameters which is narrowly defined.

For known embossing calendars comprising a roller pair which consists of a male part and a female part, pre-adjustment of both rollers in axial and radial orientation is regularly performed manually by a service technician. To do this, the roller pair is pre-adjusted visually and thereafter vernier adjusted with the aid of test strips. Adjustment tolerances are in a range of 1/100 mm. Such a task can be performed only by a skilled person trained for the corresponding type of calendar, since a misregistration would immediately destroy the roller pair during operation.

To facilitate pre-adjustment of the roller pair, DE 101 11 025 A1 discloses a method for contactless adjustment of the roller nip as well as embossing rollers used therein. The method as described requires that for axially aligning the embossing roller pair each embossing roller must be provided with at least one marking which is arranged on the shell surface of the embossing roller, wherein its position is oriented in relation to the engraving present on the surface. Furthermore, for radially aligning both embossing rollers, at least one end face of each embossing roller is provided with at least one further marking, wherein the position of the further marking is oriented in relation to the engraving present on the surface of this embossing roller. Finally, adjustment of the roller pair is performed by moving both embossing rollers, while maintaining parallelity of their shell surfaces and preventing contact between the shell surfaces relatively to another until all previously described markings on said first and said second embossing rollers are in line and until a pre-determined roller nip is adjusted.

The method for adjusting the roller nip as previously described, however, requires that at least one marking is respectively to be provided on the shell surface as well as on one end face of both rollers. Preferably, even at least two indications are present on the shell surface of each embossing roller, wherein alignment is performed by bringing respectively associated marking pairs in line. According to DE 101 11 025 A1, the last mentioned step is performed by optically detecting the markings as well as a subsequent image processing method.

Therefore, the apparatus known from the prior art comprise the disadvantage, that a plurality of markings is necessary to achieve the mandatory precision for adjusting the roller pair for reliable operation. Furthermore, the known apparatus provide respectively at least one marking both on the roller shell surface and on at least one of the end faces to achieve at the desired alignment of the roller pairs both in axial and in radial direction. This requires normally that at least two scanning devices are necessary, one for reading the marking on the shell surface and one for reading the marking on one of the end faces. Moreover, the necessary image processing and analysis involves an increased overhead in data processing.

It is therefore the object of the invention to propose an apparatus for adjusting the radial and axial position of a roller pair as well as a roller pair suitable for use in said apparatus which do not comprise the aforementioned disadvantages. The apparatus according to the invention shall merely provide a minimum number of markings as well as reading devices while ensuring the precision of alignment necessary for operation.

According to the invention, this object is solved by a roller pair according to claim 1. Claim 8 defines an apparatus for aligning a roller pair by using the roller pair according to the invention. Preferred embodiments are subject-matter of the subclaims.

For the roller pair for embossing web-shaped material according to the invention, it is provided that at least one of said rollers comprises at least two markings on the shell surface of the roller of which two markings in each case in an extension form an angle α, with 0<α<90°. The markings are arranged depending on the stamping pattern, so that after detecting the markings with the necessary precision, the axial and radial positions of the respective roller can be derived.

Each marking has at least two extensions, in case it is engraved, three. For an engraved marking, the engraving depth represents one extension, whereas the two other extensions extend on the shell surface of the respective roller. For symmetrical markings, said extensions run parallel to the symmetry axis of the respective marking.

In a preferred embodiment, both rollers possess precisely two markings which include an angle α=45°. Since for the roller pair according to the invention all markings are present on the shell surface of the respective roller, it is possible that these reference markings are engraved simultaneously with the embossed engraving into the roller surface at one setting, so that also exact positioning with respect to the embossed engraving is ensured. Another advantage of the fact that all markings are present on the shell surface is, that it is also possible to read or to detect them by means of a single measuring device.

In a further embodiment, at least one marking comprises a boundary extending at least in sections parallel to the roller axis. For analysis of the markings exclusively contactless means, such as light barriers, laser, ultrasonic sensors, inductive sensors or air sensors are provided. The operation distance between sensors and embossing rollers associated therewith results in a lower contamination of during embossing operation.

For the embodiment having one marking as previously mentioned which comprises at least in sections a boundary parallel to the roller axis, position determination uses the fact that the boundary of the marking which is at least in sections parallel to the roller axis, represents a reference for the radial alignment of the corresponding roller, whereas the marking arranged at an angle α, preferably α=45°, is a measure for the axial position of the same roller. Both markings can be arranged immediately adjacent to another, so that a quick reading of both markings is allowed, they may, however, be also further spaced apart.

Detecting of the markings with the aid of the aforementioned means is based on the analysis of the contrast of the reflected measuring signal which increases when the measuring signal strikes the marking across the boundary when the roller is rotating. Normally it is associated therewith that the reflected signal, at least for a short time, comprises a significant oscillation of intensity. This is the reason that for measuring markings of the invention the widths and depths thereof are not relevant, since the measurement takes place merely by detecting the boundary and the gradient of reflection of the measuring signals associated therewith. In the preferred embodiment having embossed markings, coloring of the marking to achieve at an optical contrast is not required. Furthermore, an imaging measuring system is also not necessary for a roller pair according to the invention. Preferably, detection of engraved markings in form of milled takes place by a laser measuring method, wherein, however, processing of a laser sensor image is also not required.

The apparatus for aligning a roller pair according to the invention comprises at least a scanning device, at least an adjustment device and at least one analysis and control unit. The scanning device allows contactless scanning of the markings on at least one roller with the aid of one of the aforementioned means, wherein each scanning device is configured to scan all markings of exactly one roller. The adjustment device serves to align at least one of the clamped rollers at least in an axial and a radial direction. The analysis and control unit firstly determines the position of the rollers in the axial and radial directions from the measuring signals of the scanning devices. Depending on the determined result, it will then send a control signal to the adjustment device to act onto the respective roller in a correcting manner.

Preferably, the apparatus as previously described uses rollers which both respectively comprise two markings. Such an apparatus then possesses two scanning devices and two adjustment devices, wherein each adjustment device is associated with exactly one roller. Such an apparatus enables to determine the exact alignment of both rollers independent from another and to adjust them separately corresponding to the respective orientation.

Immediately after clamping the roller pair, the rollers are normally totally unaligned which has also the consequence that the applied markings are not immediately in an area where they can be read by the scanning device as provided. To still enable this, the analysis and control unit is in an appropriate embodiment pre-adjusted such that the rollers are rotated until an analysis of all markings is accomplished before actually approaching and aligning them. It has turned out to be appropriate that the analysis and control unit performs a plausibility test also during the adjustment process as well as during operation of the roller pair by repeatedly taking measurement signals of the scanning devices by repeated detection of the relative alignment of both rollers in axial and radial directions and, if necessary, sends a correcting control signal to the adjustment devices. Such an active regulation of the roller alignment is even possible in service and prevents dejusting which degrade the quality of the embossing result or even leads to an impairment of the roller pair.

To further enhance the embossing result, an embodiment of the apparatus according to the invention additionally comprises a hydraulic bearing clearance adjustment of the radial embossing roller bearing for reducing vibrations of the embossing rollers. Preferably, the bearing clearance adjustment occurs via temperature monitoring of the single bearing sites.

Further details of the invention are described in the drawing with the aid of schematically represented exemplary embodiments. Herein shows:

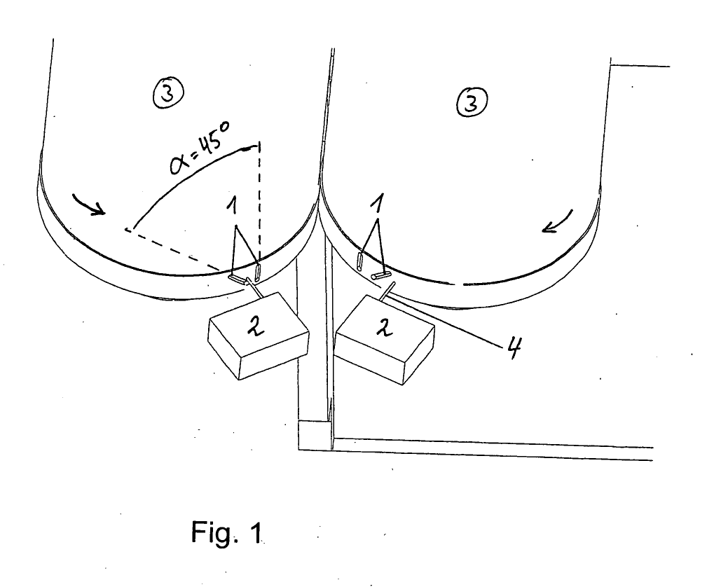

FIG. 1 a perspective view of an apparatus according to the invention by using a roller pair according to the invention.

FIG. 1 shows a roller pair 3 according to the invention, wherein each of the rollers comprises a pair or markings 1. Each pair of markings 1 consists of a first marking 1 running parallel to the roller axis and a second marking 1 running at an angle α between 0° and 90°, here α=45°, with respect to first marking 1. The markings are arranged respectively in axial direction at the border of the first and second rollers on the shell surface thereof. Thereby, simple scanning of markings 1 by means of the first and second scanning devices 2 is possible which are respectively arranged at a distance which is free selectable as far as possible, to the roller surface and consequently to markings 1. Contactless scanning of markings 1 is in the present example performed by means of a laser beam 4. Depending on a selected direction of rotation, either markings 1 running parallel to the roller axis or angled markings 1 are firstly detected. Having the directions or rotation as drawn, markings 1 running parallel to the roller axis would be detected firstly, so that at a constant angle velocity of the rollers 3 the necessary influence of the adjustment devices provided for aligning rollers 3 to achieve the desired synchronisation can be derived from the time offset between detection of marking 1 running parallel to the roller axis on first roller 3 and corresponding marking 1 on second roller 3 with the aid of analysis and control units associated with scanning devices 2.

Once synchronisation of the rollers is achieved, again from the time offset between detection of marking 1 running parallel to the roller axis and detection of angled marking 1 on the same roller 3, the position of the respective roller 3 in axial direction can be concluded subsequently to take corresponding adjustment measures with the aid of the analysis and control unit in cooperation with the respective adjustment device. As already described, for detecting the time offsets as mentioned, preferably detections of the marking boundaries of both markings which are crossed at first in rotational direction are relevant. The engraved markings are geometrically identical, therefore possess identical extensions, even though oriented differently, namely at an angle α=45° between a respective extension of the first and the second marking.

The features disclosed in the foregoing description, in the claims and/or in the accompanying drawings may, both separately and in any combination thereof, be material for realising the invention in diverse forms thereof.

1-14. (canceled)

15. A roller pair for embossing web-shaped materials, consisting of a male part and a female part, which during operation are arranged in specified axial and radial positions to produce a roller nip, wherein at least one of said rollers has at least two markings on the shell surface thereof, of which two markings in each case in an extension form an angle α, with 0<α<90°, and wherein the markings are arranged depending on the stamping pattern.

16. The roller pair of claim 15, wherein said markings include an angle α=45°.

17. The roller pair of claim 15, wherein both rollers comprise exactly two markings.

18. The roller pair of claim 15, wherein said markings are engraved grooves.

19. The roller pair of claim 15, wherein said markings produce an optical contrast on the shell surface of the roller.

20. The roller pair of claim 18, wherein said engraved markings are bordered by a pronounced boundary at the transition between shell surface and marking.

21. The roller pair of claim 15, wherein at least one marking comprises a boundary running parallel to the roller axis at least in sections.

22. An apparatus for aligning a roller pair by using a roller pair of claim 15, comprising
at least one scanning device for contactless scanning said markings on at least one of said rollers, wherein each scanning device is configured to scan all markings of exactly one of said rollers;
at least one adjustment device for aligning at least one clamped roller in an axial and in a radial direction; and
an analysis and control unit which determines the position of at least one of said rollers in an axial and a radial direction from the measuring signal of said at least one scanning device and sends a control signal corresponding to the determination to the adjustment device.

23. The apparatus of claim 22, wherein each roller respectively comprises two markings, characterized by two scanning devices and two adjustment devices, wherein each adjustment device is associated with exactly one roller.

24. The apparatus of claim 22, wherein said analysis and control unit makes the rollers rotate until an analysis of all markings has been performed at least once.

25. The apparatus of claim 22, wherein said scanning device comprises a directed light beam, a laser, a light barrier, an ultrasonic sensor, an inductive sensor or an air sensor.

26. The apparatus of claim 22, wherein said analysis and control unit, also during the adjustment process as well as during operation of said roller pair performs a plausibility test by repeatedly detecting relative orientation of both rollers in axial and radial directions with respect to another and, if necessary, sends a correcting control signal to the adjustment device.

27. The apparatus of claim 22, further comprising a hydraulic bearing clearance adjustment of the radial roller bearing for reducing vibrations of said rollers.

28. The apparatus of claim 27, wherein said bearing clearance adjustment occurs by temperature monitoring of the single bearing sites.
